(19) United States
(12) Patent Application Publication
(10) Pub. No.: US 2023/0079885 A1
(43) Pub. Date: Mar. 16, 2023

(54) INTEGRATED DOUBLE BAFFLE WALL GREASE INTERCEPTOR

(71) Applicant: Schier Products Company, Shawnee, KS (US)

(72) Inventors: Benjamin F. Brown, Overland Park, KS (US); Tad Asay, Overland Park, KS (US)

(21) Appl. No.: 17/945,359

(22) Filed: Sep. 15, 2022

Related U.S. Application Data
(60) Provisional application No. 63/244,349, filed on Sep. 15, 2021.

(51) Int. Cl. B01D 17/02; B01D 21/24; B01D 21/30

(52) U.S. Cl. CPC B01D 17/0211; B01D 21/2483; B01D 21/30

(57) ABSTRACT

A separation device and method for treating effluent mixture streams including one or more liquid component(s). The device and method can utilize gravity and/or hydromechanical separation to separate non-water components from the effluent mixture. The device and method more particularly relates to an improved large capacity grease interceptor having an integrally formed double baffle sidewall within the tank reservoir to control the movement of effluent mixture within the reservoir, as well as significantly improve structural integrity of the device and ease of manufacturing and assembly.

### CROSS-REFERENCE TO RELATED APPLICATIONS

The present application claims the priority benefit of U.S. Provisional Patent Application Ser. No. 63/244,349, filed Sep. 15, 2021, entitled INTEGRATED DOUBLE BAFFLE WALL GREASE INTERCEPTOR, incorporated by reference in its entirety herein.

### BACKGROUND OF THE INVENTION

### Field of the Invention

The present disclosure relates to systems and devices for treating flowable streams including one or more liquid component(s), and in particular methods, systems and devices for use in gravity and/or hydromechanical separation of components of an effluent mixture. The present invention more particularly relates to an improved large capacity grease interceptor having an integrally formed double baffle sidewall within the tank reservoir to control the movement of effluent mixture within the reservoir, as well as significantly improve structural integrity of the device and ease of manufacturing and assembly.

### Description of Related Art

Effluent separation units often treat streams containing three broad categories of components: (a) lighter-than-water component(s), (b) water component(s), and (c) heavier-than-water component(s). A conventional separation unit separates out at least some of the non-water components as the stream flows between an input and an output of the unit. Exemplary non-water components include solids, sands, fats, oils, greases and the like. Effluent separation devices for separating water from solids, greases and the like are often designed to perform much of the separation process as the stream flows through a separation compartment. Effluent flow is commonly delivered to the separation compartment by an input conduit, and transported from the separation compartment by an output conduit resulting in a substantially horizontal effluent flow path across the separation unit. Typically, separation compartments are located at or below the ground-level of an area proximate to an effluent source, such as a commercial kitchen.

An advanced effluent treatment device is provided in U.S. Pat. No. 7,481,321, which is hereby incorporated herein by reference. Inlet and outlet conduits of the '321 patent are each connected to a separation chamber adjacent respective apertures in the end wall of the chamber. The inlet aperture is configured to provide fluid communication between the separation chamber and an inlet conduit that delivers the mixture to the interceptor. The inlet diffuser is in fluid communication with the inlet aperture and the inlet diffuser includes a body portion located within the separation chamber and an elongated outlet aperture that extends through the body portion to provide fluid communication between the inlet conduit and the separation chamber.

Existing separation tanks for handling large capacities (i.e., 1,000 gallons or more) include respective inlets and outlets with inlet and outlet diffusers at each opposing end wall. These large capacity interceptors comprise a main tank or body portion of a generally cylindrical shape onto which is welded each opposing end wall, support feet, and access hatch(s) with riser(s). The end walls also comprise separately welded reinforcement ribs. These larger capacity interceptors also include an intermediate sidewall or baffle within the chamber that interrupts the flow of effluent and separates the separation chamber into two respective reservoirs (the inlet chamber and the outlet chamber). The baffle piece is a separately welded intermediate wall that is installed in the chamber and is welded to the perimeter of the interior sidewall of the chamber. The baffle includes one or more flow holes for the effluent to pass through from the inlet chamber to the outlet chamber. The baffle enhances mixing and movement of the effluent to facilitate separation of the water and non-water components. The manufacturing and assembly of such large capacity interceptors takes, on average, 6 days.

There is a need for an alternative to the standard designs outlined above that may be more easily maintained and constructed, while also providing an acceptable, and in some cases superior, degree of separation. This background discussion is intended to provide information related to the present inventive concept which is not necessarily prior art.

### SUMMARY OF THE INVENTION

In one embodiment, there is provided an effluent separation device comprising an effluent reservoir comprising at least first and second separation chambers in fluid communication with each other, and an integrally formed double baffle wall residing within a cross-section of the effluent reservoir configured to control the movement of an effluent mixture therethrough and to provide structural support to the effluent reservoir. The first separation chamber comprises a first baffle wall and the second separation chamber comprises a second baffle wall. The first and second baffle walls abut each other to present the double baffle wall.

In one embodiment, there is provided a method of separating an effluent mixture in the effluent separation device described above. The method comprises: (a) introducing an effluent mixture into the first separation chamber, the effluent mixture comprising water and one or more components having a density greater than water or less than water; (b) at least partially separating the water from the one or more components of the effluent mixture in the first chamber, thereby providing a grease depleted effluent layer; and (c) passing at least a portion of the grease depleted effluent layer from the first separation chamber into the second separation chamber through the double baffle wall for further separation in the second separation chamber.

In one embodiment, there is provided a method of constructing an effluent separation device. The method comprises: (a) molding first and second monolithically-formed bodies defining respective first and second effluent separation chambers, the first and second separation chambers comprising respective first and second baffle walls each having one or more effluent apertures formed therein; (b) positioning the first and second monolithically-formed bodies such the first and second baffle walls abut each other to present a double baffle wall and such that the one or more apertures in each of the first and second sidewalls are aligned to define one or more effluent passages through the double baffle wall; and (c) affixing the first and second monolithically-formed bodies to one another.

### BRIEF DESCRIPTION OF THE DRAWINGS

All dimensions shown in the figures are exemplary and should not be taken as limiting on the overall scope of the invention.

FIG. 1 is a perspective view of an effluent separation device in accordance with one embodiment of the present invention;

FIG. 2A and FIG. 2B are perspective views of a separation chamber in accordance with one embodiment of the present invention;

FIG. 3 is a perspective view of two separation chambers that can be used form an effluent separation device in accordance with one embodiment of the present invention;

FIG. 4 is a side cross-section view of an effluent separation device in accordance with one embodiment of the present invention;

FIG. 5 is a perspective view of an effluent separation device, including a close-up view of a recess for connecting separation chambers, in accordance with one embodiment of the present invention;

FIG. 6 is a perspective cutaway view of an effluent separation device in accordance with one embodiment of the present invention;

FIG. 7A is a perspective view of an effluent separation device including an intermediate separation chamber in accordance with one embodiment of the present invention; and

FIG. 7B is an exploded view of the separation device shown in FIG. 7A.

### DETAILED DESCRIPTION

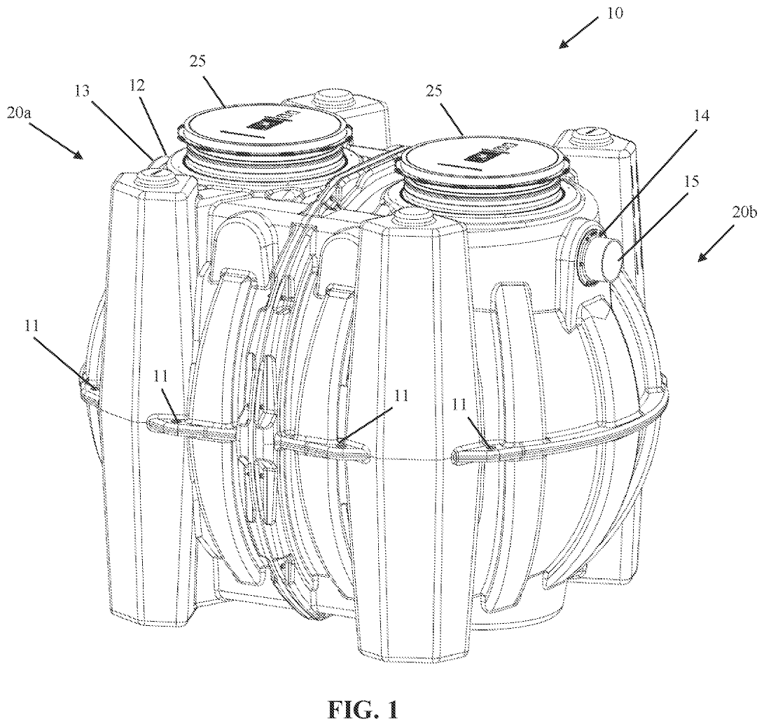

The present disclosure is broadly concerned with an improved large capacity separation device, such as a grease interceptor, that can be assembled in less than 1 hour, typically in around 30 minutes. An exemplary separation device 10 is shown in FIG. 1. The separation device 10 comprises two distinct separation chambers 20a, 20b, each chamber 20a, 20b having a hollow liquid-receiving reservoir defined by a respective monolithically-formed body. When joined together in the assembled configuration, the two chambers 20a, 20b cooperatively form the separation device 10 having an inlet 12 and an outlet 14 in fluid communication with the inlet 12. In one or more embodiments, the separation device 10 is constituted by substantially identical or symmetrical halves molded from a synthetic resin and then joined together.

In certain embodiments, each separation chamber 20a, 20b is a monolithic body, which means that it is integrally formed as a single unitary body, which is seamless and of an uninterrupted, single material. As such, the terms “monolithic” or “monolithically-formed” or “integrally formed” as used herein mean that the structure is formed as of a single contiguous piece or material, and does not refer to structural integration of separate components or mean that the body is otherwise constructed of multiple parts or elements that have been connected together (even if permanently). In certain embodiments, the body is molded of high density polyethylene or other suitable resin, with a minimum nominal thickness of 7/16-inch. In one or more embodiments, sections of the body are further reinforced with solid molded portions of additional thicknesses, such as areas for bolted connections and reinforcing belt around the center of the domed wall. In one or more embodiments, the belt area of the tank is also designed with pass through holes 11 for use in both lifting the tank as well as securing it down to a pallet for shipping. For example, holes 11 formed in proximity to the double baffle wall joint (described below) can protect the joint during lifting via a crane during installation. In one or more embodiments, the monolithically-formed bodies are rotationally molded.

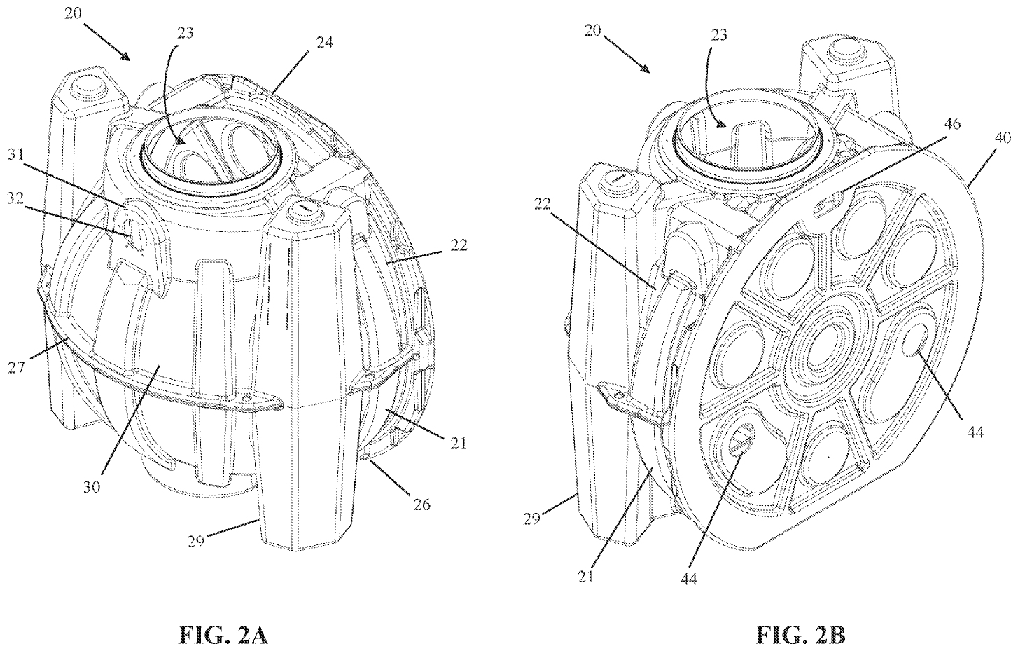

Referring now to FIGS. 2A and 2B, an exemplary separation chamber 20 is shown. Separation chamber 20 comprises an end wall 30 having an aperture 32 (e.g., 6-inch) for an inlet 12 or outlet 14 and an opposing baffle end wall 40 (also referred to herein as a baffle sidewall or baffle wall). In one or more embodiments, the end wall 30 (i.e., the outer end wall comprising the inlet or outlet) is of a substantially convex, rounded, and/or domed irregular shape, while the baffle wall 40 is of an irregular but substantially vertical shape. The inlet/outlet end wall 30 includes an inlet or outlet aperture 32 or port that extends through the sidewall projections 31 of the end wall 30 to provide fluid communication between the exterior of the separation chamber 20 and the interior reservoir. Each separation chamber 20 comprises a tank sidewall(s) 22, a top 24, and a bottom 26, which along with the end wall 30 and baffle wall 40, cooperatively define a tank reservoir for containing the mixture during separation. In one or more embodiments, the tank end wall 30 and sidewall(s) 22 are of an irregular shape. In one or more embodiments, the sidewall(s) 22 are configured with one or more support or stabilizing projections, such as legs 29, as well as one or more reinforcing ribs 21 and/or belts 27. Reinforcing ribs or belts may be present on the end wall 30 as well. Each of said foregoing structures is integrally formed with the separation chamber body 20. In certain embodiments, the top 24 of each separation chamber 20 presents an access opening 23 and a removable cover 25 configured to span the access opening 23 and enclose the reservoir. Each inlet 12 and/or outlet 14 may be provided with a conduit 13, 15 or projection, which may be separately attached, for connection to the appropriate upstream and downstream fixtures.

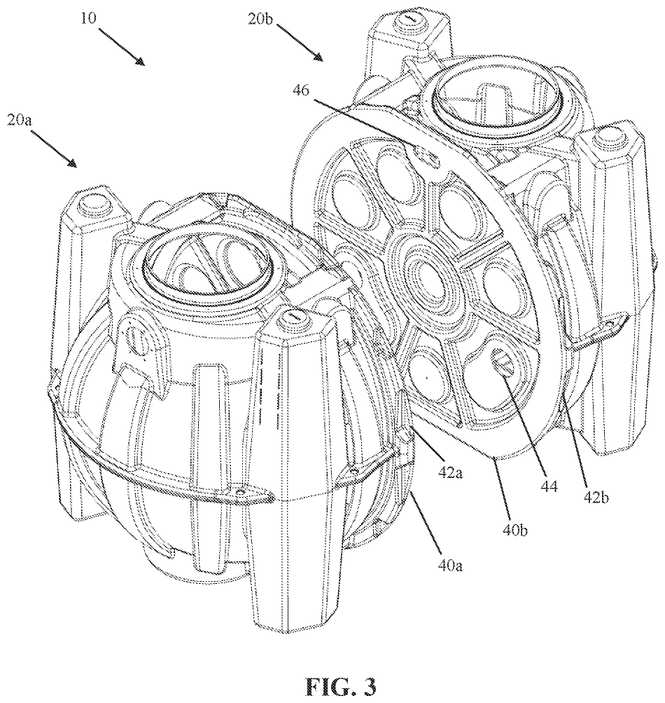

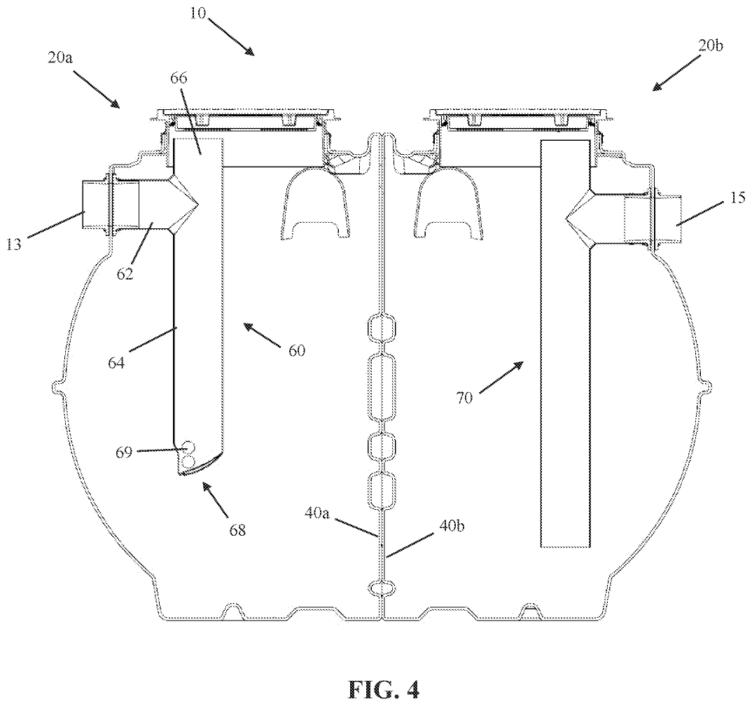

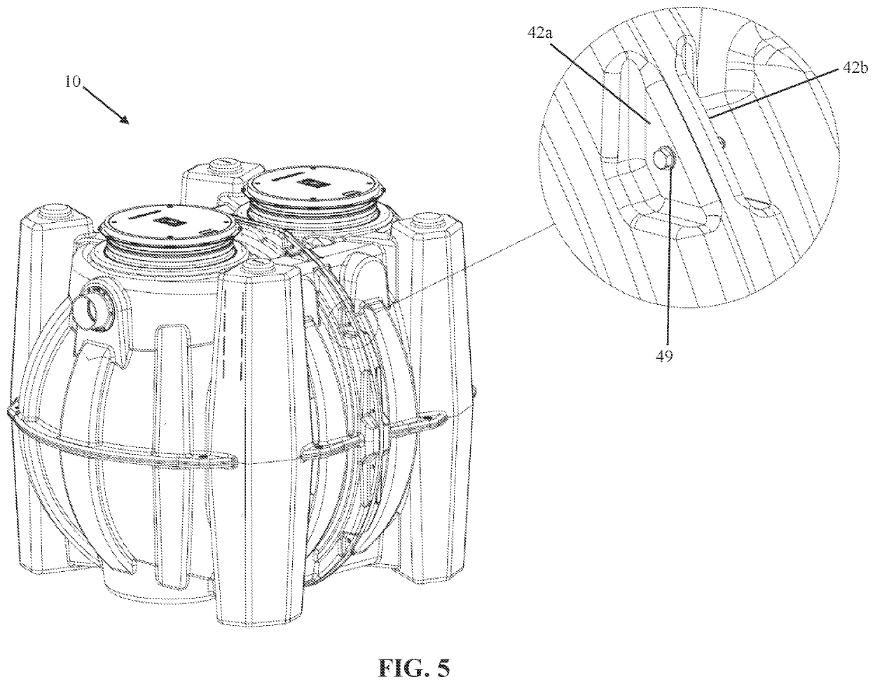

As shown in FIG. 3, in one or more embodiments, each separation chamber 20a, 20b, comprises a monolithic body defining one half of the separation device 10. In one or more embodiments, each monolithic body is a substantially identical half of the separation device 10. The two halves cooperate to form the interceptor device, such that the two halves are joined together by urging the respective baffle walls 40a, 40b together. As best illustrated in FIG. 4, in the assembled configuration, the baffle walls 40a, 40b are configured to abut against each other, and are advantageously configured to have complementary recessed areas 42a, 42b (shoulders or lips) around the perimeter of the baffle walls, 40a, 40b for receiving a bolt 49, screw, clamp, or other connection means for attaching the monolithic bodies together (see FIG. 5). These recessed areas 42a, 42b preferably comprise solidly molded resin (i.e., are not hollow).

Before assembly (i.e., connecting the separation chambers 20a, 20b), each baffle wall 40a, 40b is provided with one or more effluent apertures 44 formed therein to allow effluent flow between the chambers 20a, 20b, for example from the first separation chamber 20a into the second separation chamber 20b during normal operation. During assembly, the apertures 44a, 44b are aligned to define one or more effluent passages through the double baffle wall. The size, shape, and position of the apertures 44 can be adjusted or modified as desired to modify the flow of the effluent, provided that the apertures are aligned as between the first and second chambers 20a, 20b. In certain embodiments, the apertures 44 are positioned in a lower half of the baffle walls 40a, 40b. In certain embodiments, the apertures 44 have a generally circular shape and may have a diameter of about 2 inches to about 6 inches. In certain embodiments, the apertures formed in the second baffle wall 40b have a smaller cross-sectional area than the apertures formed in the first baffle wall 40a. The use of different diameter apertures advantageously allows for a more secure seal to be made for effluent passing through the double baffle wall 40a, 40b, for example, by providing overlapping surfaces to be easily welded together during assembly. Additionally, the arrangement of a larger diameter aperture on the upstream side baffle wall 40a of the double baffle wall than the downstream side baffle wall 40b can advantageously provide for improved effluent flow mechanics through the apertures. The baffle walls 40a, 40b further include an aligned vent hole 46, which is positioned above the water line during normal operation. Each of these apertures 44 and/or vent hole 46 can be pre-formed via molding, or drilled or cut out prior to assembly.

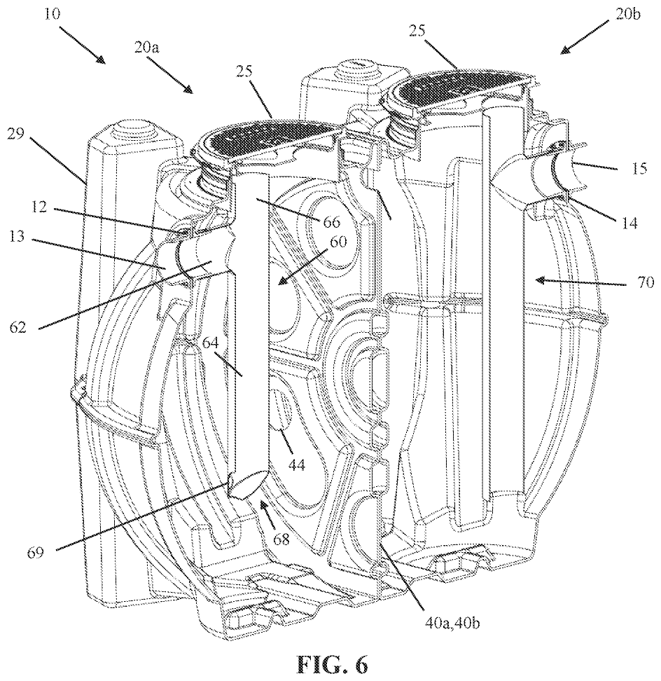

As best shown in FIG. 6, in the assembled configuration, the separation device 10 comprises two distinct chambers in fluid communication with one another, separated by a double wall baffle (comprising abutting baffle walls 40a, 40b). Once assembled, the monolithic bodies can be welded, for example around a perimeter of the double baffle wall, or otherwise suitably permanently affixed to one another. The resulting assembled configuration thus comprises a separation tank comprising a first chamber 20a and second chamber 20b separated by a double wall baffle 40a, 40b, an inlet 12, and an outlet 14. It will be appreciated that the assembled double baffle wall 40a, 40b imparts important structural reinforcement to the assembled unit. For example, the assembled double baffle wall 40a, 40b provides bracing and support against deformation of the unit, particularly when installed in underground locations, with the double-wall thickness and I-beam type design (see FIG. 4) running through the center of the unit.

In use, an effluent mixture generally flows from an effluent source (not shown), through the inlet 12, and into the first separation chamber 20a. The effluent mixture generally comprises water and non-water components, such as solids, sands, fats, oils, greases and the like. The effluent source may comprise commercial, industrial, and/or individual drains, which may include restaurant sink drains. In certain embodiments, the effluent mixture is fed via inlet aperture 12 into an inlet diffuser 60 installed within the first separation chamber 20a. The inlet diffuser 60 generally comprises an inlet conduit 62 coupled to the chamber end wall 30. Inlet conduit 62 extends within the first separation chamber 20a and connects to an upright conduit section 64. The upright conduit section also presents an upper inlet inspection port 66 and an inlet discharge 68, which may include one or more openings 69 for directing the effluent mixture into the first separation chamber 20a. Preferably, the inlet discharge 68 is located within the separation chamber 20a below the water line (i.e., within the predominantly water or grease-depleted layer and below the grease layer) during normal operation.

In certain embodiments, the inlet diffuser 60 splits the incoming effluent mixture into at least one, two, or three (or more) paths that directs the effluent mixture into different portions of the separation chamber, thereby utilizing the entire liquid volume of the first separation chamber 20a for efficient grease separation. The calibrated openings 69 in the diffuser 60, in combination with the shape of the chamber 20a and the baffle 40a, greatly reduce effluent turbulence. Thus, the effluent mixture enters the chamber 20a without disturbing any existing grease or sediment layers. Rather, the flow that enters the unit through the diffuser 60 is preferably directed against a concave or rounded interior portion of end wall 30a that deflects the flow in all directions and drives the effluent mixture around the chamber 20a. In certain embodiments, at least a portion of the effluent mixture is directed into a corner tower chambers, for example as defined by legs 29, formed in the separation chamber 20a. This causes the turbulence to dissipate in the first chamber 20a, which in certain embodiments, ensures that a calm laminar flow enters the second chamber 20b through the baffle double wall apertures 44a, 44b. This allows the effluent mixture to begin separating into one or more distinct layers, as described in greater detail below. Eventually, the at least partially separated effluent passes as a grease-depleted layer through the baffle apertures 44 into the second chamber 20b for further separation.

In certain embodiments, a passive separation process occurs during the progression of the effluent stream through the at least first and second separation chambers. The passive separation process is distinguished from active separation processes that require pumps and/or other moving parts to effect separation of the effluent stream. In certain embodiments, the separation process is a hydromechanical separation process, which may comprise a gravity separation process aided by flow control, air entrapment, interior baffles, and/or other mechanism. In certain such embodiments, separation device 10 may therefore be considered a hydromechanical interceptor as defined in ASME A112.14.3-2018. The double baffle wall 40a, 40b itself is designed for rigidity but also with the option to place the apertures 44a, 44b in several places around the face of the baffle. In one or more embodiments, the apertures 44a, 44b are circular for ease of manufacturing as well as better flow characteristics. The apertures may also be positioned farther away from the center of the device and/or at a location closed to the top of the device, as compared to existing designs, which can encourage the effluent flow to transmit the grease up and away from the bottom of the outlet diffuser 70 where the discharge draws from.

In particular embodiments, a gravity separation process occurs in each separation chamber during the progression of the effluent mixture from device the inlet 12 to the outlet 14. During the separation process in each separation chamber, one or more light components (i.e., having a density less than water) buoyantly migrate to form a top layer near a static water line. Such light components may include grease, fats, oils, and/or other components having a density less than water. Additionally or alternatively, one or more heavy components (i.e., having a density greater than water) may sink to form a bottom layer adjacent the bottom of the tank. Such heavy components may include debris, food waste, and/or other solids having a density greater than water. As a result of the gravity separation process in the separation chambers, the outlet diffuser 70, which has an uptake inlet below the water line but above the solids layer, allows only effluent which is free of grease (and other light components) and solids (and other heavy components) to exit the device 10, via outlet 14, which fluidly communicates with an effluent drain such as a sewer (not shown).

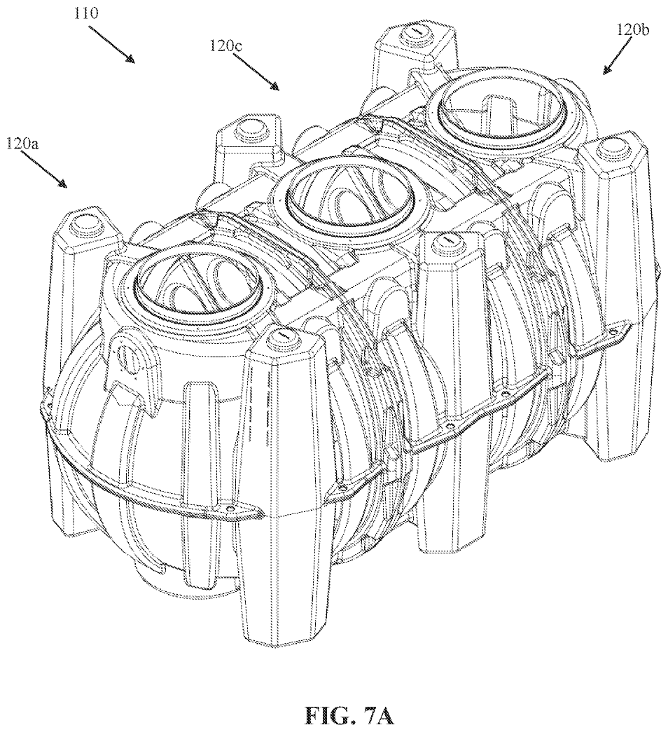

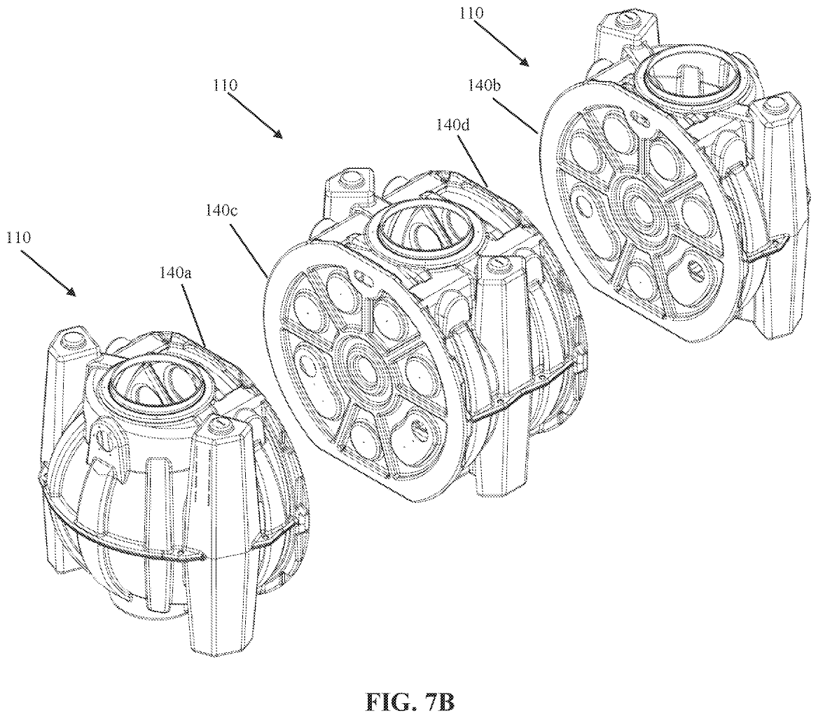

In one or more embodiments, the capacity of the separation device may be expanded by adding one or more additional monolithic separation chambers in sequence, such as depicted in the device 110 shown in FIGS. 7A and 7B. In such embodiments, the inlet chamber 120a and outlet chamber 120b are separated by one or more intermediate separation chambers 120c. The intermediate separation chamber 120c is monolithically formed and comprises a tank sidewall 130 and two opposing baffle end walls 140c, 140d that cooperatively define the reservoir. In the assembled configuration, a first baffle end wall 140c of the intermediate chamber 120c is configured to abut the baffle end wall 140a of the inlet separation chamber 120a, while the other (second) baffle end wall 140d of the intermediate chamber 120c is configured to abut the baffle end wall 140b of the outlet separation chamber 120b. Such a configuration would comprise two intermediate double wall baffles separating the interceptor into three distinct separation chambers in fluid communication with each other. It will be appreciated that additional intermediate separation chambers can be added in sequence between the end chambers as needed or desired to further expand capacity of the unit. For example, a 600-gallon intermediate separation chamber can be combined with two 500 gallon end chambers to make a 1600 gallon unit. Likewise, two 600-gallon intermediate separation chambers could be used to make a 2200 gallon unit.

The innovative design of the present separation device increases and maintains the structural integrity of the present device, as compared to existing grease interceptors, while dramatically decreasing fabrication time. The resulting large-capacity interceptor device is suitable for both buried and above-ground applications. As noted above, the structure includes integrally formed legs or supports such that additional external support structures are not needed. The corner “towers,” in particular, are designed to support the domed end walls when installed above grade with the center welded/bolted joint being the key structural element with the double wall thickness and “I-beam” design. In addition, the shape and configuration reduce deformation of the separation chambers during use, including under elevated temperatures. The units are suitable for continuous operating temperatures up to about 150° F.

As described herein, the separation device preferably has an irregular shape including rounded convex ribs formed in the tank walls. However, it is within the scope of the invention that device has other geometries, including but not limited to, traditional rectangular prism or cuboid geometries having a defined base, ceiling, sidewalls, and edges. The separation device can be sized to accommodate virtually any suitable inlet flow rate and/or grease content of the effluent streams. However, in certain embodiments, separation device is configured to receive and effectively treat from about 5 to about 600 gallons per minute, 10 to about 400 gallons per minute, or about 20 to about 200 gallons per minute of effluent. In certain embodiments, separation device has a liquid capacity of at least about 1000 gallons or more.

Although the above description presents features of preferred embodiments of the present inventive concept, other preferred embodiments may also be created in keeping with the principles of the invention. Furthermore, these other preferred embodiments may in some instances be realized through a combination of features compatible for use together despite having been presented independently in the above description.

Furthermore, directional references (e.g., top, bottom, front, back, up, down, etc.) are used herein solely for the sake of convenience and should be understood only in relation to each other. For instance, a component might in practice be oriented such that faces referred to as “top” and “bottom” are sideways, angled, inverted, etc. relative to the chosen frame of reference.

It is further noted that the term annular or aperture shall be interpreted to mean that the referenced object or structure extends around a central opening so as to be generally toroidal or ring-shaped. It is not necessary for the object to be precisely circular, nor does the object have to be continuous. Similarly, the term toroidal shall not be interpreted to mean that the object must be circular or continuous, as other geometries may be used including oval, polygonal, rectangular, etc. depending upon the particular feature design.

It should still further be noted that, in one construction, the separation device is molded from high density polyethylene to inhibit corrosion and leaking. In other constructions, the container can be formed from other suitable materials, including other types of polymers or plastics, metals, composites, and the like (e.g., fiberglass reinforced composites, etc.) using any suitable method for preparing a monolithic structure.

The preferred forms of the invention described above are to be used as illustration only and should not be utilized in a limiting sense in interpreting the scope of the present inventive concept. Obvious modifications to the exemplary embodiments, as hereinabove set forth, could be readily made by those skilled in the art without departing from the spirit of the present inventive concept.

Additional advantages of the various embodiments of the invention will be apparent to those skilled in the art upon review of the disclosure herein and the working examples below. It will be appreciated that the various embodiments described herein are not necessarily mutually exclusive unless otherwise indicated herein. For example, a feature described or depicted in one embodiment may also be included in other embodiments, but is not necessarily included. Thus, the present invention encompasses a variety of combinations and/or integrations of the specific embodiments described herein.

As used herein, the phrase “and/or,” when used in a list of two or more items, means that any one of the listed items can be employed by itself or any combination of two or more of the listed items can be employed. For example, if a structure is described as containing or excluding components A, B, and/or C, the composition can contain or exclude A alone; B alone; C alone; A and B in combination; A and C in combination; B and C in combination; or A, B, and C in combination.

The present description also uses numerical ranges to quantify certain parameters relating to various embodiments of the invention. It should be understood that when numerical ranges are provided, such ranges are to be construed as providing literal support for claim limitations that only recite the lower value of the range as well as claim limitations that only recite the upper value of the range. For example, a disclosed numerical range of about 10 to about 100 provides literal support for a claim reciting “greater than about 10” (with no upper bounds) and a claim reciting “less than about 100” (with no lower bounds).

1. An effluent separation device comprising:
an effluent reservoir comprising at least first and second separation chambers in fluid communication with each other; and
an integrally formed double baffle wall residing within a cross-section of the effluent reservoir configured to control the movement of an effluent mixture therethrough and to provide structural support to the effluent reservoir,
the first separation chamber comprising a first baffle wall and the second separation chamber comprising a second baffle wall, the first and second baffle walls abutting each other to present the double baffle wall.

2. The device of claim 1, wherein each of the first and second separation chambers comprise a hollow liquid-receiving reservoir defined by respective first and second monolithically-formed bodies.

3. The device of claim 2, wherein the first and second monolithically-formed bodies have substantially identical or symmetrical construction.

4. The device of claim 2, wherein the first and second monolithically-formed bodies are permanently affixed together at one or more positions around a perimeter of the double baffle wall.

5. The device of claim 1, wherein the first and second baffle walls each comprise a plurality of ribs extending radially outward from a central portion of the baffle walls.

6. The device of claim 1, wherein the first and second baffle walls each comprise a peripheral flange having a substantially flat surface, and wherein the substantially flat surfaces of the flanges contact each other to form an outer support structure for the double baffle wall.

7. The device of claim 1, wherein the first and second baffle walls each comprise a one or more effluent apertures formed therein which are aligned to allow a grease depleted effluent layer to pass therethrough.

8. The device of claim 7, wherein the one or more effluent apertures formed in the second baffle wall have a smaller cross sectional area than the one or more effluent apertures formed in the first baffle wall.

9. The device of claim 7, wherein the first and second baffle walls each comprise a one or more vent holes formed at a position above the one or more effluent apertures and which are aligned to allow fluid communication between the first and second separation chambers.

10. The device of claim 1, wherein each of the first and second separation chambers comprise a substantially convex, rounded, and/or domed irregular shape end wall having an aperture formed therein configured to pass an inlet or outlet effluent therethrough.

11. The device of claim 10, further comprising an inlet diffuser installed within the first separation chamber and configured to receive an effluent mixture through the inlet aperture and to direct at least a portion of the effluent mixture in the direction of the end wall of the first separation chamber.

12. The device of claim 10, further comprising an outlet diffuser installed within the second separation chamber and configured to receive a separated effluent stream comprising predominantly water and to direct the separated effluent stream through the outlet aperture formed in the end wall of the second separation chamber.

13. The device of claim 1, wherein each of the first and second separation chambers comprise an access opening formed in a top portion of the device and configured to allow removal of accumulated solids, grease, fats, oils, and/or other non-water components from the first and second separation chambers.

14. The device of claim 1, further comprising a third separation chamber in fluid communication with the first and second separation chambers, wherein the second separation chamber resides between the first and third separation chambers and comprises a third baffle wall opposite the second baffle wall, wherein the third separation chamber comprising a fourth baffle wall, the third and fourth baffle walls abutting each other to present a second double baffle wall residing within a second cross-section of the effluent reservoir.

15. A method of separating an effluent mixture in the effluent separation device of claim 1, the method comprising:
(a) introducing an effluent mixture into the first separation chamber, the effluent mixture comprising water and one or more components having a density greater than water or less than water;
(b) at least partially separating the water from the one or more components of the effluent mixture in the first chamber, thereby providing a grease depleted effluent layer; and
(c) passing at least a portion of the grease depleted effluent layer from the first separation chamber into the second separation chamber through the double baffle wall for further separation in the second separation chamber.

16. A method of constructing an effluent separation device, the method comprising
(a) molding first and second monolithically-formed bodies defining respective first and second effluent separation chambers, the first and second separation chambers comprising respective first and second baffle walls each having one or more effluent apertures formed therein; and
(b) positioning the first and second monolithically-formed bodies such the first and second baffle walls abut each other to present a double baffle wall and such that the one or more apertures in each of the first and second sidewalls are aligned to define one or more effluent passages through the double baffle wall; and
(c) affixing the first and second monolithically-formed bodies to one another.

17. The method of claim 16, wherein the affixing (c) comprises bolting and/or welding the monolithically-formed bodies around a perimeter of the double baffle wall.

18. The method of claim 17, wherein the one or more effluent apertures formed in the second baffle wall have a smaller cross sectional area than the one or more effluent apertures formed in the first baffle wall, wherein the affixing (c) further comprising welding together the one or more effluent apertures formed in the first baffle wall and the one or more effluent apertures formed in the second baffle wall.

19. The method of claim 16, wherein the first and second monolithically-formed bodies have substantially identical or symmetrical construction.

20. The method of claim 16, wherein the molding (a) comprises rotational molding a synthetic resin to form the first and second monolithically-formed bodies.
